(19) United States
(12) Patent Application Publication
(10) Pub. No.: US 2006/0246961 A1
(43) Pub. Date: Nov. 2, 2006

(54) Portable device with an integrated wireless earphone

(75) Inventor: Wen-Hung Wang, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/390,148

(22) Filed: Mar. 28, 2006

(30) Foreign Application Priority Data
Apr. 27, 2005 (TW) 94113535

(51) Int. Cl. H04M 1/00

(52) U.S. Cl. 455/569.1

(57) ABSTRACT

The present invention provides a portable device with an integrated wireless earphone. According to the present invention, a trench is formed in the main part. The shape and scale of the trench is related to the wireless earphone so as to collect and fix the wireless earphone in the trench to avoid losing the wireless earphone.

### RELATED APPLICATIONS

The present application is based on, and claims priority from, Taiwan Application Serial Number 94113535, filed Apr. 27, 2005, the disclosure of which is hereby incorporated by reference herein in its entirety.

### FIELD OF THE INVENTION

The present invention relates to a portable device, and more particularly, a portable device with an integrated wireless earphone.

### BACKGROUND OF THE INVENTION

The mobile phone has become increasingly more popular to the point that it has become an indispensable tool for people in daily life. Although the mobile phone is convenient for people, the hand-operated type mobile phone often distracts the attention of a driver to possibly cause an accident. Therefore, many hands-free type mobile phone systems have been developed, such as a wireless earphone communicating with a mobile phone. Such communication frees the hands from the mobile phone and may significantly reduce the possibility of an accident.

However, since there is no space designed in the typical mobile phone for storing the wireless earphone, a user can often lose the earphone. Moreover, the mobile phone and the wireless earphone each contain a microphone and an earphone. When a user directly uses the mobile phone for communication, the microphone and earphone in the wireless earphone are not used, and vice versa. This redundancy is costly and wasteful.

### SUMMARY OF THE INVENTION

It is therefore the object of the present invention to provide a portable device with an integrated wireless earphone. In one aspect of the present invention is to provide a portable device that only includes one microphone and one earphone therein for realizing both hand-operated and hands-free communication.

In another aspect of the present invention is to provide a wireless earphone that may issue and receive a searching signal. Accordingly, the present invention provides a portable device with an integrated wireless earphone. A trench is formed in the portable device. The shape and scale of the trench is related to the wireless earphone. Therefore, the wireless earphone can be collected and fixed in the trench to prevent the wireless earphone from being lost.

The present invention also provides the aforementioned portable device with an integrated wireless earphone wherein the microphone and earphone installed in the wireless earphone are commonly used for both hand-operated and hands-free usage. Therefore, the product cost can be reduced.

In another embodiment, a transmitter and receiver are installed in the portable device and the wireless earphone. When the distance separating the portable device from the wireless earphone is larger than a certain distance, a warning signal is issued to notify the user.

### BRIEF DESCRIPTION OF THE DRAWINGS

The foregoing aspects and many of the attendant advantages of this invention will become more readily appreciated and better understood by referencing the following detailed description, when taken in conjunction with the accompanying drawings, wherein:

FIG. 1A illustrates a schematic diagram of a mobile phone with an integrated wireless earphone according to embodiment of the invention;

FIG. 1B illustrates a schematic diagram of a main part of the mobile phone according to embodiment of the invention;

FIG. 1C illustrates a schematic diagram of an integrated wireless earphone part of the mobile phone according to embodiment of the invention; and

FIG. 1D illustrates a schematic diagram of using a wireless earphone of the mobile phone according to embodiment of the invention.

### DETAILED DESCRIPTION OF THE PREFERRED EMBODIMENT

A mobile phone is described in the following to embody and explain the present invention. However, it is noticed that this embodiment does not limit the application of the present invention. In other words, the invention is suitable for any portable device needing wireless communication with an earphone.

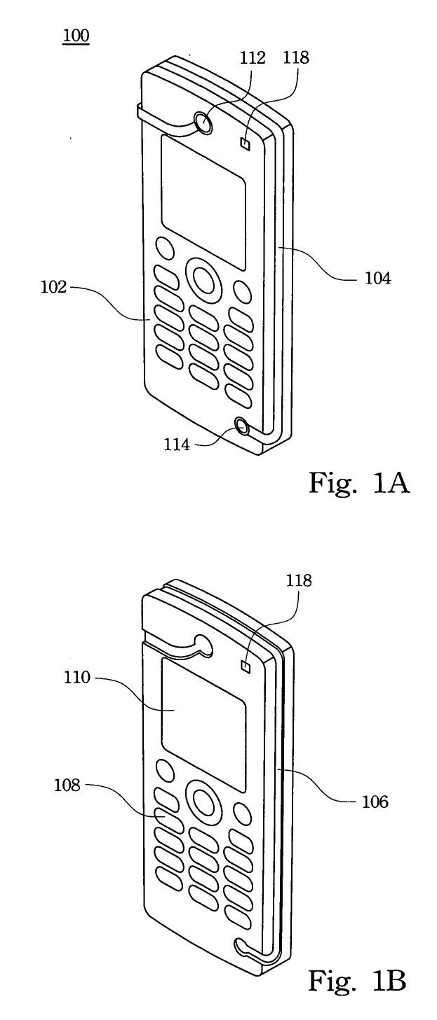

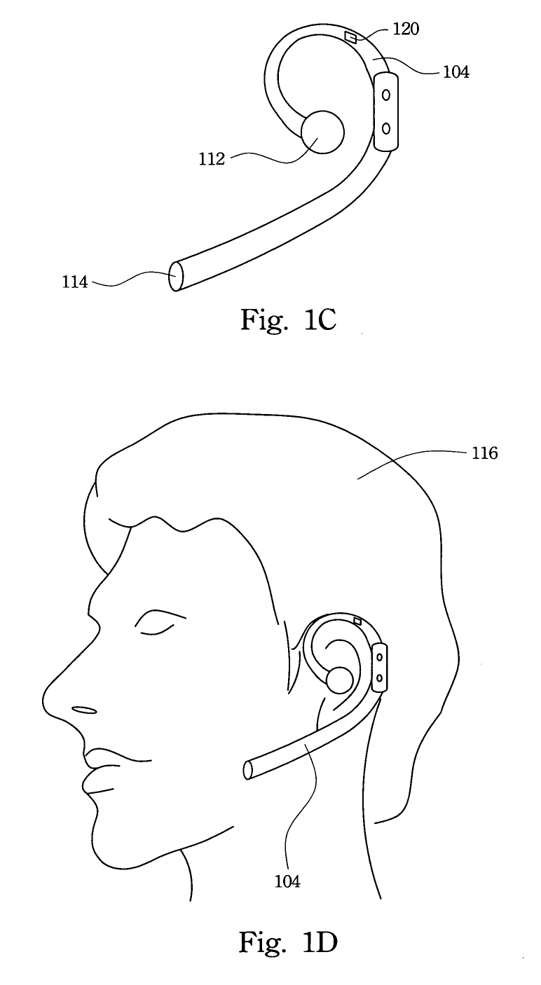

FIG. 1A illustrates a schematic diagram of a mobile phone with an integrated wireless earphone according to embodiment of the invention. The mobile phone system 100 includes a main part 102 and an earphone 104 separable from the main part 102. FIGS. 1B and 1C respectively illustrate schematic diagrams of the main part 102 and the earphone 104. According to this embodiment, this earphone 104 is a Bluetooth earphone. This Bluetooth earphone can wirelessly communicate with the main part 102. The material for forming the earphone 104 is a pliable material. Therefore, the user 116 can adjust the shape of the earphone 104 to fit his face.

As shown in FIG. 1B, a trench 106 is formed in the main part 102. The shape and scale of the trench 106 is related to the shape and scale of the earphone 104. The earphone 104 can be located and fixed in the trench 106. According to the preferred embodiment, the location of the trench 106 in the main part 102 is from the bottom, approximately under the keyboard 108, along the side to extend to the top, approximately over the display 110. However, in other embodiments, the location of the trench 106 fits other shapes of the main part.

When the wireless earphone 104 is located in the trench 106, the earphone 112 is located over the display 110 and the microphone 114 is located under the keyboard 108. Moreover, both the earphone 112 and the microphone 114 are exposed from the mobile phone. Therefore, the user can hold this mobile phone directly and use the earphone 112 and the microphone 114 to communicate with others. At this time, the Bluetooth wireless communication technology is used between the wireless earphone 104 and the main part 102 It is noticed that other types of wireless communication technology may be used in the present invention. In other words, the wireless earphone 104 is only separated from the main part 102 when the user wants hands-free communication, which can significantly reduce the likelihood of the wireless earphone 104 being lost.

According to the mobile phone structure of the embodiment, when the wireless earphone 104 is located in the trench 106, the earphone 112 and the microphone 114 of the wireless earphone 104 replaces the earphone and microphone typically installed in the main part 102. In other words, according to the embodiment, the earphone 112 and the microphone 114 are responsible for both hand-operated and handsfree communication. Thus, only one earphone and one microphone are required and are commonly used in the final product, which reduces the production cost and also prevents losing the wireless earphone 104.

In other embodiments, an additional earphone and microphone are installed in the main part 102 to provide the user an additional communication type. In other words, the embodiment of invention can collocate any type in the main part. When the main part has an earphone and a microphone therein, a trench is only formed in the main part for locating and fixing the wireless earphone to avoid losing it. In the embodiment, the only requirement for the location of the trench in the mobile phone is to avoid affecting the communication when using the earphone and microphone in the main part.

In other embodiments, an additional transmitter/receivers 118 and 120 are respectively installed in the main part 102 and the wireless earphone 104 as shown in FIGS. 1B and 1C. The transmitter/receivers 118 and 120 are responsible for detecting the distance separating the main part 102 from the wireless earphone 104 to avoid losing the wireless earphone 104. When the distance is larger than a certain distance, a warning signal is issued by the main part 102 or the wireless earphone 104 to notify the user. It is noticed that any well-known element that can detect the distance may be used as the transmitter/receivers 118 and 120 in the present invention. Moreover, the certain distance is changeable according to user requirements. In other embodiments, an active searching method is adopted. For example, when a user is searching for the main part 102 or the wireless earphone 104, he can actively trigger the transmitter/receiver 118 or 120 to issue a searching signal. When a corresponding transmitter/receiver installed in the main part 102 or the wireless earphone 104 receives this searching signal, a warning signal is issued by the corresponding transmitter/receiver to notify the user of its position.

Accordingly, in embodiment of the invention, a trench is formed in the main part. The shape and scale of the trench is related to the wireless earphone so as to collect and fix the wireless earphone in the trench to avoid losing the wireless earphone. The microphone and earphone installed in the wireless earphone are commonly used. Therefore, the production cost can be reduced. Moreover, transmitter/receivers are installed in the main part and the wireless earphone respectively. When the distance separating the portable device from the wireless earphone is larger than a certain distance, such as 1 m, 2 m or 3 m, a warning signal is issued to notify the user to further prevent the wireless earphone from being lost.

As is understood by a person skilled in the art, the foregoing descriptions of the preferred embodiments of the present invention are illustrations of the present invention rather than limitations thereof. Various modifications and similar arrangements are included within the spirit and scope of the appended claims. The scope of the claims should be accorded to the broadest interpretation so as to encompass all such modifications and similar structures. While preferred embodiments of the invention have been illustrated and described, it will be appreciated that various changes can be made therein without departing from the spirit and scope of the invention.

What is claimed is:

1. A portable device, comprising:
a main part having a trench, wherein the trench is formed on the surface of main part; and
a wireless earphone located in the trench, wherein the wireless earphone is separable from the trench.

2. The portable device of claim 1, wherein the portable device is a mobile phone.

3. The portable device of claim 2, without a microphone or an earphone.

4. The portable device of claim 2, having a microphone and an earphone.

5. The portable device of claim 1, wherein said wireless earphone is a Bluetooth earphone.

6. The portable device of claim 1, wherein the material of the wireless earphone is a pliable material.

7. The portable device of claim 1, further comprising a transmitter/receiver installed in the main part and the wireless earphone respectively for detecting a distance between them.

8. The portable device of claim 7, wherein when said distance is larger than a certain distance, a warning signal is issued by the transmitter/receiver.

9. A portable device, comprising:
a main part having a trench, wherein the trench is formed on the surface of main part;
a wireless earphone having an earphone and a microphone located in the trench, wherein the trench fits the earphone and the microphone for communication and the wireless earphone is separable from the main part; and
a transmitter/receiver installed in the main part for detecting a distance between the main part and the wireless earphone, wherein when the distance is larger than a certain distance, a warning signal is issued by the transmitter/receiver.

10. The portable device of claim 9, wherein the portable device is a mobile phone.

11. The portable device of claim 9, without a microphone or an earphone.

12. The portable device of claim 9, having a microphone and an earphone.

13. The portable device of claim 9, wherein the material of the wireless earphone is a pliable material.
